(19) United States
(12) Patent Application Publication
(10) Pub. No.: US 2007/0131714 A1
(43) Pub. Date: Jun. 14, 2007

(54) Multiple aerosol dispensing apparatus

(75) Inventors: Luc Jutras, Ste-Julie (CA); Denis Faucher, Chateau Richer (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: LES PRODUITS DE TOITURE FRANSYL LTEE

(21) Appl. No.: 11/541,803

(22) Filed: Oct. 3, 2006

Related U.S. Application Data
(60) Provisional application No. 60/722,435, filed on Oct. 3, 2005.

(51) Int. Cl. B67D 5/52; B60P 3/22; B67D 5/64

(52) U.S. Cl. 222/135; 222/608; 222/174

(57) ABSTRACT

The present invention provides an apparatus for simultaneously dispensing the content of at least two aerosol cans. The apparatus includes a support having at least two holders, a pressure mechanism, an actuator affixed to the support and operationally connected to the pressure mechanism. The pressure mechanism is operable to vary the pressure exerted on the nozzles, thereby adjusting the intensity of the outflow from the cans. Thus, the actuator enables an operator to adjust the intensity of the flow of fluid and to spray simultaneously the content of at least two aerosol cans. The present apparatus is preferably mobile and may be used to dispense adhesive substances on a surface.

### FIELD OF THE INVENTION

The present invention relates to the field of tools for building construction, and especially concerns an apparatus for dispensing the content of at least two aerosol containers on a surface.

### BACKGROUND OF THE INVENTION

Aerosol dispensers are available on the market for products such as perfume, insecticide, adhesive substances or paint.

Traditional aerosol dispensers are designed to act on one container at the time in order to liberate the substance therein. For example, in the field of building construction, painting machines are used for laying or spraying paint on roads or walls, but they are generally limited to dispensing the content of only one container at a time.

Some multiple container dispensers are also known in the art, such as for example shown in U.S. Pat. Nos. 6,968,982 (BURNS), US 6,308,863 (HARMAN), US 6,189,810 (NERUSHAI et al.), US 5,005,736 (PORTAS) and US 4,826,048 (SKORKA et al.). These patents disclose dispensers arranged for lodging at least two cans, bottles or the like.

The prior art also discloses portable sprayers such as those of US patent applications 2005/0284951 A1 and 2005/0284958 A1 (CLARKE, III et al.), both teaching a portable battery-powered sprayer for dispensing two liquid products at the same time. In the first application, the dispenser is provided with a handle for lifting and displacing the dispenser. In the second patent application, the nozzles of the apparatus are arranged to dispense the liquid content of two different containers at two different flow rates, with different droplet sizes and into different target zones.

In the prior art, there is also provided wheeled dispensers such as the marking devices of U.S. Pat. Nos. 5,785,214 and 5,749,522 (SMRT). SMRT discloses devices each provided with wheels and a handle for pulling or dragging the device and actuating the discharge of the aerosol contents. There is also provided, in U.S. Pat. No. 6,698,774 B2 (DUNCAN), a spray gun provided with a parallel spacing guide, a handle so that the user can push the invention along the street and use the gun to actuate the discharge of the content of the dispenser.

In view of the prior art, there is still a need for an improved multiple dispensing device which is simple, inexpensive to make and easy and convenient to use.

### SUMMARY OF THE INVENTION

The present invention discloses an apparatus for simultaneously dispensing a content of at least two aerosol cans, each can having a nozzle apt to dispense the content when pressure is exerted thereon. The apparatus includes a support having first and second opposite ends, the support comprising at least two holders at the first end thereof, each holder being adapted to receive one of the at least two aerosol cans with the nozzle thereof oriented away from the support, the support further comprising a handle at the second end thereof. The apparatus further includes a pressure mechanism mounted at the first end of the support in cooperation with the nozzles of the at least two aerosol cans operable between a disengaged state where the pressure mechanism is disengaged from the nozzles and an engaged state where the pressure mechanism exerts a pressure on each of the nozzles. The apparatus also comprises an actuator affixed to the support and operationally connected to the pressure mechanism, the actuator being operable to move the pressure mechanism between the disengaged and engaged states. In the apparatus according to the present invention, the pressure mechanism is further operable within the engaged state to vary the pressure exerted on the nozzles, thereby adjusting the intensity of an outflow from the cans.

One important advantage of the present invention is that it enables varying the pressure exerted on the nozzles and consequently adjusting the intensity of an outflow from the cans, while still being of simple construction and adaptable to integrate the advantages of the dispensers of the prior art such as mobility.

These and other features and advantages of the present invention will be better understood upon reading of a preferred embodiment thereof with reference to the appended drawings.

### BRIEF DESCRIPTION OF THE DRAWINGS

FIG. 1 is a front view of an apparatus according to a preferred embodiment of the invention.

FIG. 2 is a perspective view from the bottom of the apparatus of FIG. 1.

FIG. 3 is a perspective view from the top of the backside of the apparatus, of FIG. 1.

FIG. 4 is a representation of the apparatus of FIG. 1 being operated by a user.

FIG. 5 is a cross-sectional side view of a portion of the apparatus of FIG. 1.

### DESCRIPTION OF A PREFERRED EMBODIMENT OF THE INVENTION

In accordance with a preferred embodiment of the invention, there is provided an apparatus for simultaneously dispensing a content of two aerosol cans or more, if required by a particular use. It will be noted that the apparatus of the illustrated embodiment, shown by way of example only, is adapted for receiving up to three aerosol cans, but that this embodiment is not considered limitative to the scope of the invention.

The aerosol cans that the apparatus of the present invention is designed to receive may be any container in which a pressurized substance is stored, provided with a nozzle responsive to pressure in order to dispense the liquid and where the outflow of the dispensed content varies as a function of the strength of the pressure applied. The present apparatus may for example be used to dispense adhesive substances on a surface in pattern to form at least two lines of adhesive substance on the surface. Of course, the present apparatus could be used for any substance generally dispensed using an aerosol can and the pattern of the dispensed substance can vary.

It will be noted that the apparatus according to the present invention can be designed to receive aerosol cans that can be identical or different. The contents to be dispensed may also vary from one can to the next on a same apparatus. Such would for example be the case when the apparatus is used to paint parallel lines of different colors.

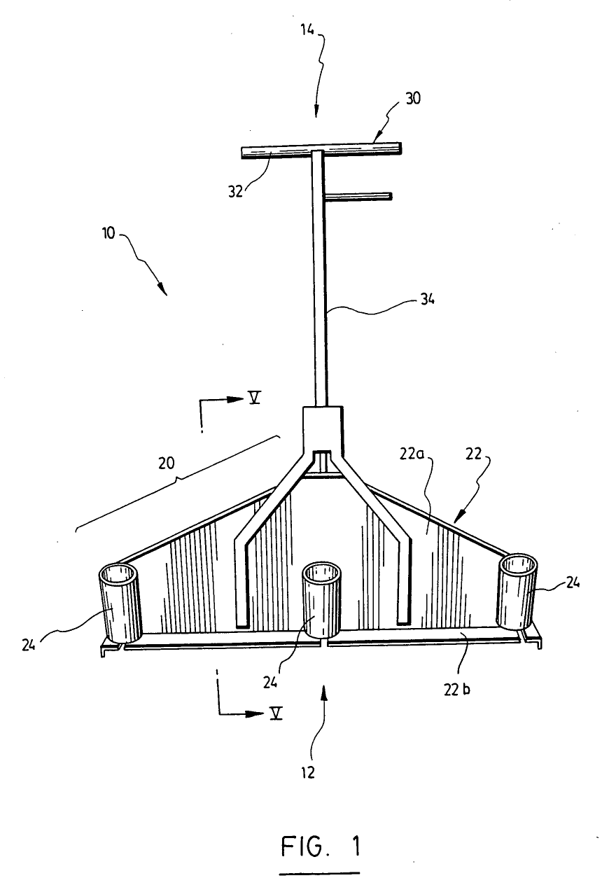

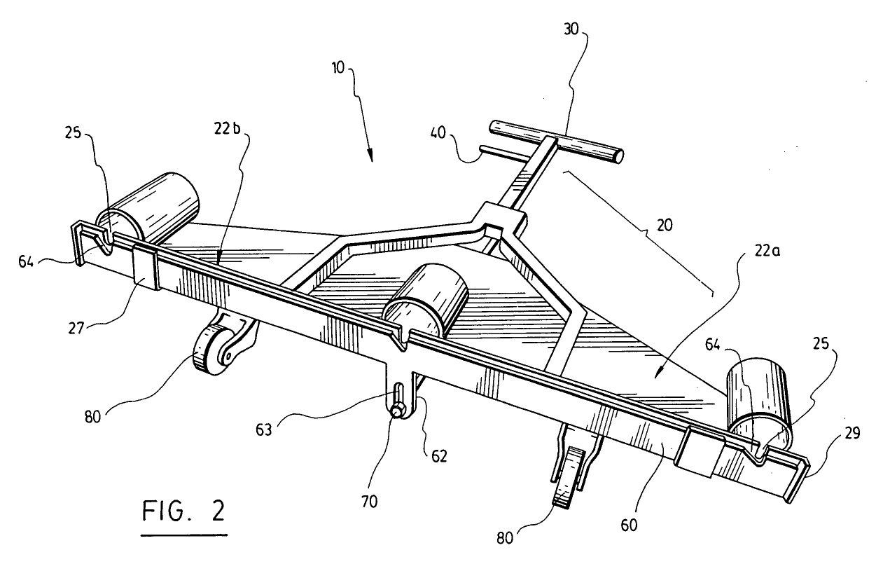

Referring to FIGS. 1 and 2, the apparatus 10 generally includes a support 20 having at least two holders 24, a pressure mechanism, an actuator 40 affixed to the support and operationally connected to the pressure mechanism. The pressure mechanism is operable to vary the pressure exerted on the nozzles, thereby adjusting an intensity of an outflow from the cans. Thus, the actuator enables an operator to adjust the intensity of the projected fluid and to spray simultaneously at a control outflow the content of at least two aerosol cans.

Referring more particularly to FIG. 1, the support 20 is shown to have first and second opposite ends 12 and 14. The support 20 includes at least two holders 24 at the first end 12. Each holder 24 is adapted to receive one aerosol cans with its nozzle oriented away from the support 20, towards a surface on which the content of the cans is sprayed. The holders 24 may be form-fitted to the shape of the aerosol cans the apparatus is designed to support. In the preferred embodiment, the support 20 further includes a base 22 generally triangular-shaped on which the holders are affixed. The support 20 further includes a handle 30 at its second end, which is preferably rigidly connected to the base 22, for example through soldering or the like. The handle is preferably T-shaped but could have any other appropriate shape.

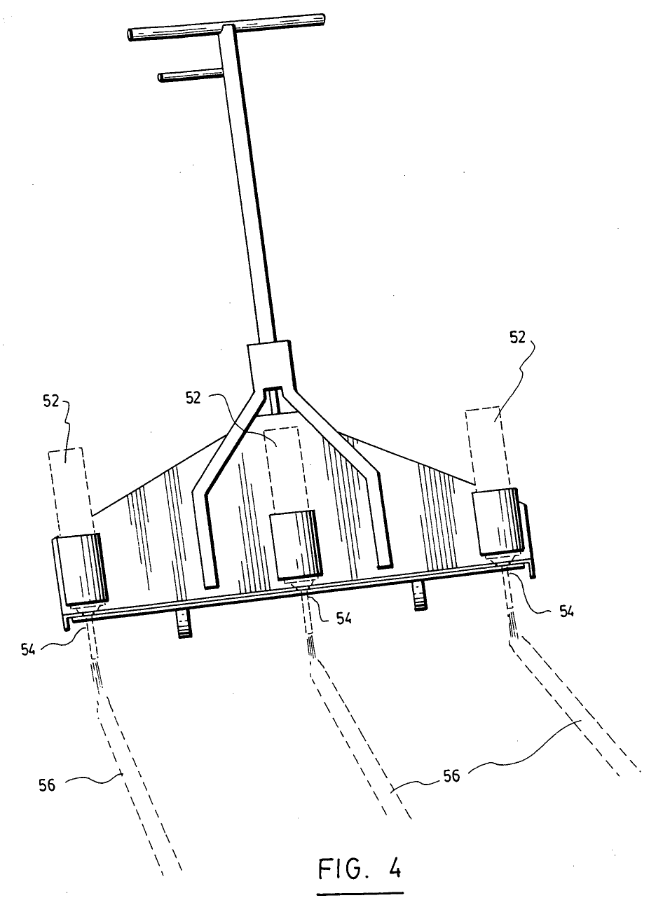

For convenience, some of the following elements are referred to as being horizontal or vertical, regarding their axis position when the apparatus 10 is used in a vertical position for dispensing the contents of aerosol cans on a floor surface. In a preferred embodiment, the base 22 includes vertical and horizontal portions 22a and 22b defining an L-shaped cross-section. The vertical portion 22a preferably carries, on its front side, the holders 24. Referring to FIGS. 2 and 4, the horizontal portion 22b preferably defined a fixed plate having three openings such as U-shaped notches 25, each positioned for receiving the nozzle 54 of an aerosol can 52 installed in one of the holders 24. In use, the top portion of the cans may abut on the fixed plate around the nozzle for support. It will be noted that in the case where the holders 24 are fit-formed to the shape of the cans, the fixed plate may be omitted. The respective extremities of the horizontal portion 22b are preferably bent at a right angle, defining two bent strips 29.

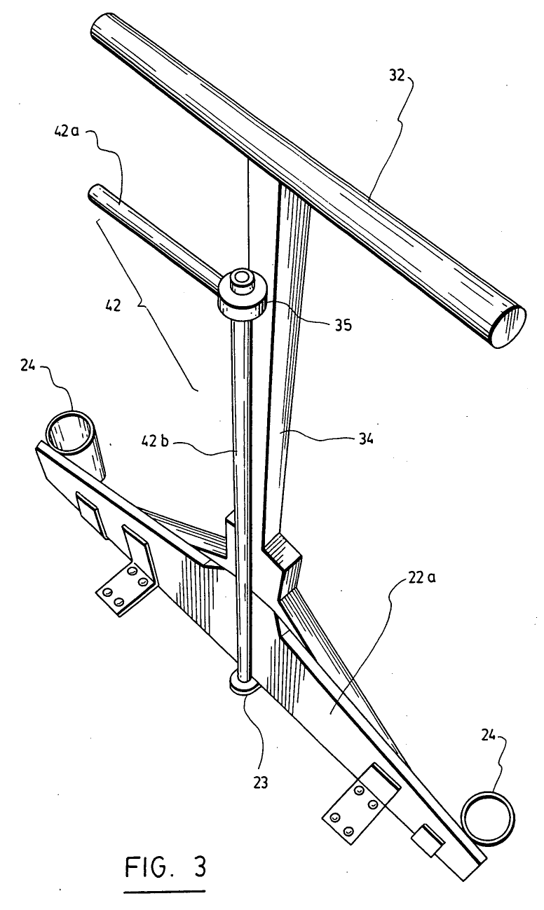

Referring to FIGS. 1, 2 and 3, and as mentioned above, a pressure mechanism is provided, and is preferably mounted at the first end 12 of the support 20, in cooperation with the nozzles 54 of the aerosol cans when such cans are installed on the apparatus. The pressure mechanism is operable between a disengaged state wherein the pressure mechanism is disengaged from the nozzles 54 and an engaged state wherein the pressure mechanism exerts a pressure on each of the nozzles 54. The pressure mechanism preferably includes a movable plate 60 movably mounted on the first end 12 of the support 60. In the illustrated embodiment, the movable plate 60 is mounted underneath the fixed plate defined by the horizontal portion 22b, in parallel thereto. The movable plate 60 is preferably provided with at least notches 64, generally in alignment with the nozzles of the fixed plate, each receiving the nozzle 54 of one of the cans. In the preferred embodiment, the movable plate 60 is carried by the horizontal portion 22b of the base 22 and is preferably supported by hook-shaped projections 27 extending from the fixed plate towards the bottom of the apparatus. The notches 64 in the movable plate 60 are preferably V-shaped, and therefore define slanted side walls around the nozzles 54. The plate 60 is translatable transversally to the nozzles, so that upon translating the plate 60, the side walls of the notches come in and out of engagement with the nozzles. It is understood that the notches 64 of the movable plate 60 could be substituted for holes or the like.

Referring to FIGS. 1, 3 and 5, the actuator 40 is affixed to the support and operationally connected to the pressure mechanism. The actuator is operable to move the pressure mechanism between the disengaged and engaged states. In the preferred embodiment the actuator is connected to the movable plate to translate it parallely to the fixed plate, thereby applying a sideways pressure on the nozzle, the degree of translation of the movable plate will determine the strength of the pressure applied on the nozzle, and therefore the outflow of content from the cans.

The actuator 40 preferably includes an arm 42 preferably L-shaped. The arm 42 is rotatably mounted on the support between its first end 12 and second end 14. The arm 42 preferably includes two joint portions 42a and 42b, a horizontal portion 42a and a vertical portion 42b. The vertical portion 42b is preferably held in place along the support by a flange 23 projecting from the vertical portion 22a of the base proximate the second end 14 of the apparatus 10, the flange 23 having a hole therethrough for receiving the vertical portion of the arm 42. Another flange 35 may further project transversally from the inferior bar 34 of the T defined by the handle 30, the flange 35 being provided with a hole for holding the vertical arm 42b. When the apparatus is not in use, the horizontal arm 42a is aligned with the superior bar 32 of the T. This position allows laying the apparatus down, without inadvertently initiating the spraying.

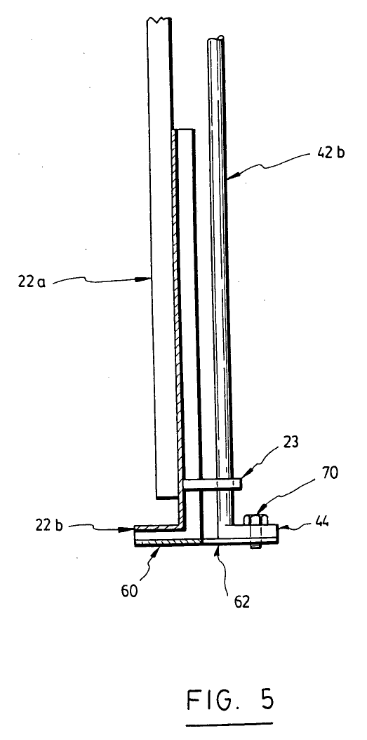

Still referring to FIGS. 1, 3 and 5, the actuator arm also includes a flange 44 extending proximate the first end 12 of the support 20. The movable plate 60 includes a projection 62 aligned with the flange 44. According to this preferred embodiment, a nut-and-bolts attachment 70, shown on FIGS. 2 and 5, connects the lateral projection 62 of the movable plate 60 and the flange 44 of the arm 42. The nut crosses both the slot of the flange 44 and the slot 63 of the lateral projection 62 of the plate 60.

In the above described embodiment of the invention, the rotation of the arm 42 around its vertical axis is transmitted to the movable plate 60 through the connection 70. The rotation commands the horizontal translation of the plate 60. The plate 60 is translated laterally. When the plate 60 is translated, the plate 60 consequently presses against the nozzles 54. As will be readily understood by one skilled the art, the extent of the rotation of the actuator will determine the extent of is the translation of the movable plate, and vary the force exerted on the nozzles by the V-shaped grooves, thereby adjusting the degree of pressure applied to the nozzles, and consequently control the outflow from the cans.

The apparatus described above may optionally be provided with a wheeled system such as wheels 80 (see FIG. 2) for the convenience of an operator willing to lay a substance 56 on a large surface or for pulling or dragging the apparatus before and after its usage. It is understood that the above-mentioned wheels 80 are replaceable by skates, sledges, rails or a combination thereof, or by any other comparable means for permitting movement of the apparatus.

Of course, numerous changes and modifications could be made to the embodiments above without departing from the scope of the invention.

1. An apparatus for simultaneously dispensing a content of at least two aerosol cans, each can having a nozzle apt to dispense said content when pressure is exerted thereon, said apparatus comprising:
a. a support having first and second opposite ends, said support comprising at least two holders at the first end thereof, each holder being adapted to receive one of said at least two aerosol cans with the nozzle thereof oriented away from the support, said support further comprising a handle at the second end thereof;
b. a pressure mechanism mounted at the first end of the support in cooperation with the nozzles of the at least two aerosol cans, and operable between a disengaged state wherein said pressure mechanism is disengaged from said nozzles and an engaged state wherein said pressure mechanism exerts a pressure on each of said nozzles; and
c. an actuator affixed to the support and operationally connected to the pressure mechanism, said actuator being operable to move the pressure mechanism between the disengaged and engaged states.
wherein said pressure mechanism is operable within said engaged state to vary the pressure exerted on said nozzles, thereby adjusting an intensity of an outflow from said cans.

2. The apparatus according to claim 1, wherein the holders are form-fitted to said cans.

3. The apparatus according to claim 1, wherein the pressure mechanism comprises a movable plate movably mounted to the first end of the support, said plate being provided with at least two notches therein, each receiving the nozzle of one of said at least two cans therethrough.

4. The apparatus according to claim 3, wherein: the notches in the movable plate defines side walls therearound; and said plate is translatable transversally to said nozzles, so that upon translating said plate the side walls of the notches come in and out of engagement with the nozzles.

5. The apparatus according to claim 2, wherein said notches of the movable plate are V-shaped.

6. The apparatus according to claim 1, wherein the support further includes a fixed plate projecting transversally proximate the first end of said support, the fixed plate having at least two openings therein, each opening receiving the nozzle of one of said at least two cans therethrough.

7. The apparatus according to claim 6, wherein the openings of the fixed plate are or U-shaped.

8. The apparatus according to claim 3, wherein the actuator comprises an actuator arm rotatably mounted to the support between the first and second end, and an actuator handle projecting transversally from the actuator arm proximate the second end of the support.

9. The apparatus according to claim 8, wherein the actuator arm comprises a flange extending proximate the first end of the support and the plate comprises a projection aligned with said flange, said apparatus further comprising a nut-and-bolts attachment connecting the flange and the projection.

10. The apparatus according to claim 9, further comprising means provided at the first end of the support for permitting movement of said apparatus along a surface.

11. The apparatus according to claim 10, wherein the means for permitting movement comprise wheels, skates, sledges, rails or a combination thereof.
